(19) United States
(12) Patent Application Publication
(10) Pub. No.: US 2014/0175295 A1
(43) Pub. Date: Jun. 26, 2014

(54) SCINTILLATOR, RADIATION DETECTION APPARATUS, AND RADIATION DETECTION SYSTEM

(71) Applicant: CANON KABUSHIKI KAISHA, Tokyo (JP)

(72) Inventors: Taiki Takei, Okegawa-shi (JP); Masato Inoue, Kumagaya-shi (JP); Shinichi Takeda, Honjo-shi (JP); Satoru Sawada, Fujioka-shi (JP); Takamasa Ishii, Honjo-shi (JP); Kota Nishibe, Honjo-shi (JP)

(73) Assignee: CANON KABUSHIKI KAISHA, Tokyo (JP)

(21) Appl. No.: 14/098,951

(22) Filed: Dec. 6, 2013

(30) Foreign Application Priority Data
Dec. 20, 2012 (JP) 2012-278605

(51) Int. Cl. G01T 1/202; G01T 1/20

(52) U.S. Cl. CPC G01T 1/202; G01T 1/2006
USPC 250/366; 428/161

(57) ABSTRACT

A scintillator includes a scintillator layer having a plurality of columnar crystals configured to convert radiation into light, and a covering layer configured to cover the scintillator layer. The scintillator layer includes a protrusion. The covering layer covers the scintillator layer to prevent the protrusion from breaking through the covering layer, and contains particles configured to convert radiation into light.

### BACKGROUND OF THE INVENTION

1. Field of the Invention

The present invention relates to a scintillator, radiation detection apparatus, and radiation detection system.

2. Description of the Related Art

There is a radiation detection apparatus including a scintillator which converts radiation into light, and a sensor array which detects the light converted by the scintillator. For example, the scintillator can be formed by deposition such as vacuum deposition using an alkali halide-based material typified by a Tl-doped CsI material. The scintillator can be formed as a columnar crystal layer containing a plurality of columnar crystals which grow by deposition. An abnormally growing portion is sometimes formed on the surface of the columnar crystal layer. Conceivable causes are bumping of a material upon deposition, entrapment of a foreign substance, and the like.

Japanese Patent Laid-Open No. 2011-2472 discloses a method of applying a pressure to the surface of a scintillator to planarize an abnormally growing portion. International Publication No. 10/010725 discloses a method of cleaning the surface of a scintillator panel by an adhesive roller or the like to remove an abnormally growing portion (splash). Japanese Patent Laid-Open No. 2005-181121 discloses a method of lowering the height of an abnormally growing portion (splash) by press work and then covering the abnormally growing portion (splash) with a protection layer.

In a radiation imaging apparatus obtained by the method of reducing or removing an abnormally growing portion, the efficiency of converting radiation into light greatly varies within the imaging area, and the quality of an obtained image is poor.

### SUMMARY OF THE INVENTION

The present invention provides a technique advantageous for obtaining a high-quality image.

The first aspect of the present invention provides a scintillator comprising a scintillator layer including a plurality of columnar crystals configured to convert radiation into light, and a covering layer configured to cover the scintillator layer, wherein the scintillator layer includes a protrusion, and the covering layer covers the scintillator layer to prevent the protrusion from breaking through the covering layer, and contains particles configured to convert radiation into light.

The second aspect of the present invention provides a radiation detection apparatus comprising: a scintillator defined as the first aspect of the present invention; and a sensor array configured to detect light converted by the scintillator.

The third aspect of the present invention provides a radiation detection system comprising: a radiation detection apparatus defined as the second aspect of the present invention; and a signal processor configured to process a signal from the radiation detection apparatus.

Further features of the present invention will become apparent from the following description of exemplary embodiments with reference to the attached drawings.

### BRIEF DESCRIPTION OF THE DRAWINGS

FIGS. 1A and 1B are schematic sectional views showing the structure of a scintillator according to an embodiment of the present invention;

FIGS. 2A to 2D are sectional views for explaining a scintillator and a radiation imaging apparatus including it according to the first embodiment of the present invention, and a method of manufacturing them;

FIGS. 3A to 3D are sectional views for explaining a scintillator and a radiation imaging apparatus including it according to the second embodiment of the present invention, and a method of manufacturing them;

FIGS. 4A to 4D are sectional views for explaining a scintillator and a radiation imaging apparatus including it according to the third embodiment of the present invention, and a method of manufacturing them;

FIGS. 5A to 5C are sectional views for explaining a scintillator and a radiation imaging apparatus including it according to the fourth embodiment of the present invention, and a method of manufacturing them; and

FIG. 6 is a view showing the arrangement of a radiation detection system according to an embodiment of the present invention.

### DESCRIPTION OF THE EMBODIMENTS

Preferred embodiments of the present invention will now be exemplarily described with reference to the accompanying drawings.

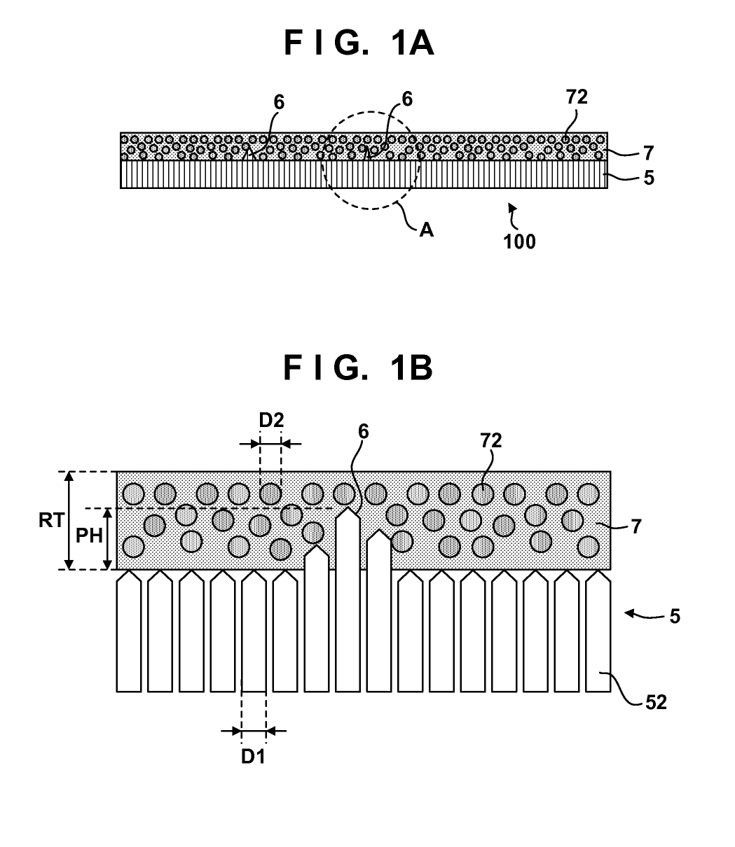

The structure of a scintillator 100 according to an embodiment of the present invention will be described with reference to FIGS. 1A and 1B. FIG. 1A is a schematic sectional view of the scintillator 100 according to the embodiment of the present invention. FIG. 1B is a schematic enlarged sectional view of a portion A in FIG. 1A. The scintillator 100 includes a scintillator layer 5 including a plurality of columnar crystals 52 for converting radiation into light, and a covering layer 7 which covers the scintillator layer 5. The scintillator layer 5 includes protrusions 6. The covering layer 7 covers the scintillator layer 5 to prevent the protrusions 6 from breaking through the covering layer 7. The covering layer 7 contains particles 72 for converting radiation into light. The particles 72 may be made of the same material as a material forming the columnar crystals 52, or a material different from it. However, the material forming the particles 72 and the material forming the columnar crystals 52 are preferably the same because characteristics (for example, wavelengths of light to be converted) for converting radiation into light in the scintillator layer 5 and particles 72 can come close to each other. The protrusion 6 is typically an abnormally growing portion generated by abnormal growth when the plurality of columnar crystals 52 grow. The covering layer 7 can be a resin layer containing the particles 72.

Degradation of the image quality (for example, variations of the sensitivity or MTF) by the protrusions 6 can be suppressed by containing, in the covering layer 7, the particles 72 for converting radiation into light. For example, the efficiency at which the scintillator layer 5 converts radiation into light is higher at portions where the protrusions 6 exist, than at the remaining portions. However, the thickness of the covering layer 7 is smaller at portions where the covering layer 7 covers the protrusions 6, than at the remaining portions. Thus, the number of particles 72 at portions where the covering layer 7 covers the protrusions 6 is smaller than that of the particles 72 at the remaining portions. This reduces variations of the efficiency of converting radiation into light in the scintillator layer 5. The shape of the particle 72 is not limited to a special shape, and can be a spherical shape, columnar shape, cuboid shape, or cone shape.

The ratio of the volume of the particles 72 to the unit volume of the covering layer 7 is preferably 10% (inclusive) to 90% (inclusive). If the ratio is lower than 10%, light generated by the particle 72 does not reach the photoelectric converter (pixel) of a sensor panel, so the effect of image improvement by containing the particles 72 in the covering layer 7 becomes insufficient. If the ratio exceeds 90%, the amount of material fixing the particles 72 becomes excessively small, making formation of the covering layer 7 difficult.

The maximum value of the dimension D2 of the particle 72 is preferably smaller than the thickness RT of the covering layer 7 and is, for example, 5 mm. The thickness RT of the covering layer 7 can be evaluated as, for example, a thickness in a region where the protrusion 6 does not exist. The thickness RT of the covering layer 7 is determined to be larger than the height of the protrusion 6. The minimum value of the dimension D2 of the particle 72 is preferably smaller than the diameter D1 of the columnar crystal 52 and is, for example, 1 μm. The covering layer 7 containing the particles 72 can be formed by applying, by a coater, roller, or the like to a surface on which the covering layer 7 is to be formed, a mixed solution of an organic solvent and a resin in which the particles 72 are dispersed, and then drying the mixed solution. Alternatively, the covering layer 7 containing the particles 72 can be formed by arranging the particles 72 on a surface on which the covering layer 7 is to be formed, applying a resin onto them, and drying the resin. Examples of the drying method are hot-air drying, hot-plate drying, and infrared drying.

The scintillator layer 5 converts radiation into light of a wavelength detectable by the photoelectric converter of the sensor panel. As the material of the scintillator layer 5, a material mainly containing alkali halide is usable. More specifically, examples of the material of the scintillator layer 5 are (a) CsI:Tl, (b) CsI:Na, (c) CsBr:Tl, (d) NaI:Tl, (e), LiI:Eu, and (f) KI:Tl.

The thickness of the scintillator layer 5 preferably falls within the range of 100 μm to 2 mm, and typically falls within the range of 150 μm to 1 mm. If the thickness of the scintillator layer 5 becomes smaller than 100 μm, the efficiency of converting irradiated radiation into light readily becomes insufficient. If the thickness of the scintillator layer 5 becomes larger than 2 mm, light generated in the scintillator layer 5 is readily absorbed and scattered in the scintillator layer 5 before it reaches a sensor array, and the quality of an obtained image can degrade.

The protrusions 6 can be formed at random on the surface of the scintillator layer 5. The protrusions 6 can be typically formed by abnormal growth. The abnormal growth can occur because a material is specifically deposited on the surface of the scintillator layer 5 during formation owing to bumping of the material (including a dopant) or the like when the columnar crystals 52 are formed by deposition. In addition, the abnormal growth can occur when a foreign substance is entrapped in the surface of the scintillator layer 5 during formation in deposition, and when a material in previous deposition remains in the deposition apparatus and is deposited again. Hence, the abnormal growth can depend on the environment and deposition conditions in the deposition apparatus.

The dimension of the protrusion 6 formed by abnormal growth depends on the deposition conditions, and is predicted to have a correlation with the thickness of the scintillator layer 5 to be formed. When a scintillator layer including 360-μm thick columnar crystals was formed from CsI:Tl by deposition, the dimension of the protrusion was a height of 0 to 200 μm from the average, defined as 0, of the surface level of the scintillator layer around (10-mmφ circular range) the protrusion. In this case, the lateral dimension of the protrusion was 200 to 600 μm in observation of a portion exposed on the surface of the scintillator layer when viewed from the top perpendicular to the scintillator layer 5. When a scintillator layer including 1-mm thick columnar crystals was formed from CsI:Tl by deposition, the dimension of the protrusion was a maximum of 1 mm from the average, defined as 0, of the surface level of the scintillator layer around (10-mmφ circular range) the protrusion. In this case, the lateral dimension of the protrusion was about 3 mm in observation of a portion exposed on the surface of the scintillator layer when viewed from the top perpendicular to the scintillator layer 5.

Examples of the scintillator layer surface level measurement method are measurement by a micrometer, measurement by a probe-type step gauge or laser microscope, and measurement by cross-section SEM observation. Measurement by a micrometer is performed at room temperature and humidity and at a measuring pressure of 5 to 10 N, and the average of measurement results at three to nine points is adopted as a result. In measurement by a probe-type step gauge, measurement is performed at a probe pressure of 1 to 15 mg in a measurement range of 1 to 100 mm or 1 mm² to 100 mm² by using a probe in which the distal end has a cone or quadrangular pyramid shape, the apex angle and the angle between opposite faces are 60° or 90°, and the radius of the distal end is 2 μm to 10 μm. In measurement by a laser microscope, the surface of a scintillator layer is observed perpendicularly from the top, and imaged while being focused from a smallest-height portion to a largest-height portion in a measurement range of 10 μm² to 100 mm² in accordance with a sample. Then, a shift of the height is calculated from a defocus in the system of the laser microscope, obtaining height information of the entire measurement range. In measurement by cross-section SEM observation, the surface level can be calculated in the SEM system from the image of a cross-section of a scintillator layer observed by the SEM at a magnification of 10 to 10,000 in accordance with a sample.

The dimension of the protrusion 6 can be measured by the same method as that for the surface level of the scintillator layer 5. However, to avoid a risk of breaking the protrusion 6, a method of observing the surface of the scintillator layer 5 perpendicularly from the top by a laser microscope is preferable.

As described above, the thickness RT of the covering layer 7 is determined to be larger than the height of the protrusion 6. In this case, the height of the protrusion 6 may be measured to determine the thickness of the covering layer 7 based on the result. Alternatively, the height of the protrusion 6 may be estimated based on the formation conditions of the scintillator layer 5 and the thickness of the scintillator layer 5 to determine the thickness of the covering layer 7 based on the result. The covering layer 7 has a function of forming a flat surface on the scintillator layer 5, and a function of protecting the scintillator layer 5 (for example, a function of preventing permeation of moisture into the scintillator layer 5, and a function of protecting the scintillator layer 5 from a shock).

The covering layer 7 is typically formed from a resin. The resin can be selected in consideration of the ease of film formation, requested hardness of the covering layer 7, the moisture permeability, and the like. Examples of the resin forming the covering layer 7 are polyimide-based, epoxy-based, polyolefin-based, polystylene-based, polyester-based, polyurethane-based, polyvinyl-based, polyamide-based, cellulose-based, phenol-based, fluorin-based, and acrylic-based resins. These resins may be used singly or as a mixture.

The ease of film formation can be considered based on the thixotropy of a resin-containing solution. The thixotropy is an index representing how the viscosity value changes depending on the stirring ability (for example, rpm) when a solution is stirred. The thixotropy indicates the difference in viscosity between the dynamic state and the static state, and is given by a numerical value called a thixotropic index. The thixotropic index of a solution can be defined as (viscosity cps at 0.3 rpm)/(viscosity cps at 3 rpm). Under this definition, the thixotropic index of a resin-containing solution preferably falls within the range of 1.0 to 5.0. If the thixotropic index exceeds 5.0, the viscosity in application, that is, in the dynamic state becomes excessively low, and the solution cannot be formed into a film, or even if it is formed into a film, the film thickness and shape greatly vary. If the thixotropic index becomes 1.0 or smaller, the viscosity in application becomes excessively high. Alternatively, since the viscosity in drying and shape fixation after drying is excessively low, no film is formed, or even if a film is formed, the film thickness and shape greatly vary. If the viscosity in application is excessively high, the resin-containing solution cannot be spread in a range where a film should be formed, or dries before spread. When the viscosity in drying and shape fixation is excessively low, even if the resin-containing solution can be spread in a range where a film should be formed, the solution runs even during drying and shape fixation, and no desired film thickness can be obtained or the shape can become nonuniform. The thixotropy depends on the component of the resin-containing solution when forming a film, and can be controlled by the type of resin and the types of solvent and additive. In particular, resins using cellulose-based and polyvinyl-based resins among the above-mentioned materials have thixotropic indices of 1.2 to 2.0 and are preferable materials.

The hardness of the covering layer 7 can be evaluated by the modulus of elasticity in tension. The modulus of elasticity in tension of a resin-containing solution in film formation should be a value smaller than that of a protrusion generated in a scintillator layer. For example, the hardness of a protrusion which may be generated in a columnar scintillator layer made of CsI:Tl is 1.5 to 3.0×10⁴ kgf/cm². Thus, the modulus of elasticity in tension of the resin-containing solution in film formation should be set to be a value smaller than this hardness. If the modulus of elasticity in tension of the resin-containing solution in film formation exceeds 3.0×10⁴ kgf/cm², the solution may break a splash in film formation. More specifically, cellulose-based, polystylene-based, and polyvinyl-based resins are preferable materials because their moduli of elasticity in tension are 1.5 or lower.

When a resin layer is used singly as a covering layer, a resin with a low moisture permeability is desirably used. In this case, the resin layer preferably has a water vapor permeability of 100 cc/m²·24 h/atm or lower. When a resin layer having a higher water vapor permeability is used singly as a covering layer, permeation of moisture cannot be satisfactorily relaxed and may cause deliquescence of the scintillator layer. In this case, a resin having a water vapor permeability of 100 cc/m²·24 h/atm or lower, such as a polyvinyl-based, polyimide-based, polystylene-based, or epoxy-based resin, is preferably used.

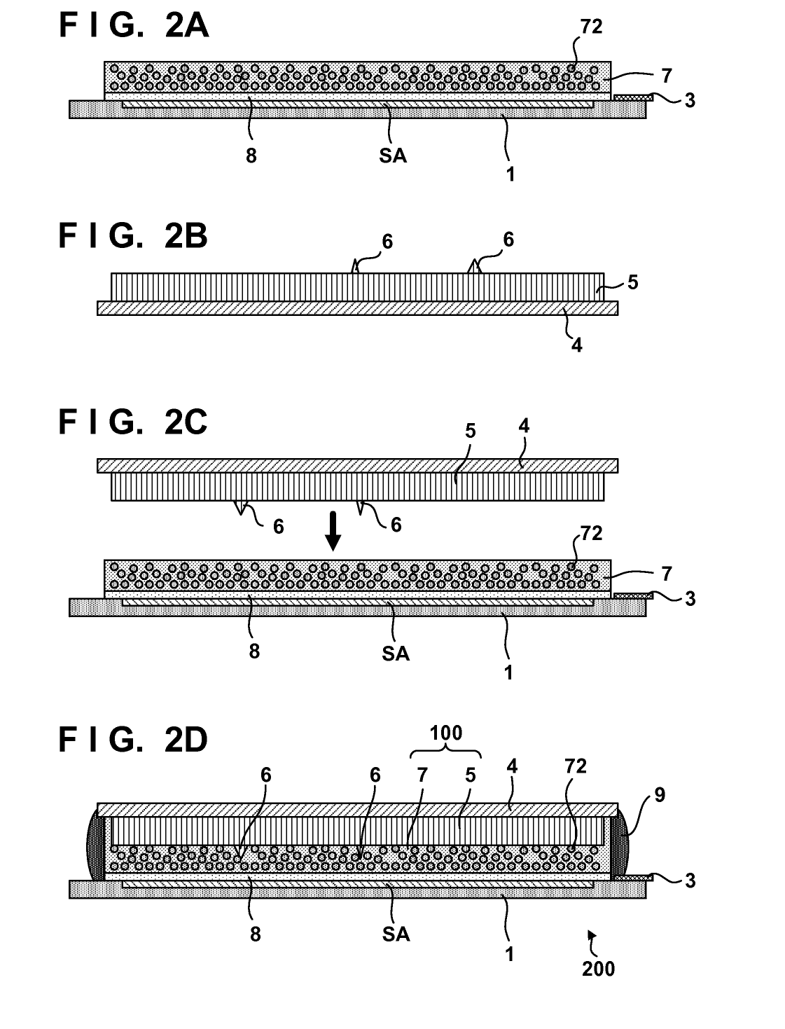

Embodiments of the scintillator 100 including the scintillator layer 5 and covering layer 7, and a radiation detection apparatus 200 in which the scintillator 100 is assembled will be explained with reference to FIGS. 2A to 2D, 3A to 3D, 4A to 4D, and 5A to 5C.

FIG. 2D shows the first embodiment of a scintillator 100 including a scintillator layer 5 and covering layer 7, and a radiation detection apparatus 200 in which the scintillator 100 is assembled. The radiation detection apparatus 200 according to the first embodiment includes the scintillator 100, a support substrate 4 which supports the scintillator layer 5 of the scintillator 100, and a sensor substrate 1. The sensor substrate 1 includes a sensor array SA which detects light converted by the scintillator 100, and a connecting portion 3 for connecting the sensor substrate 1 to an external apparatus. The sensor array SA includes two-dimensionally arrayed photoelectric converters. The photoelectric converter can be, for example, a MIS sensor, PIN sensor, or TFT sensor, but is not limited to them. The support substrate 4 can have a reflection surface on the side of the scintillator layer 5. The covering layer 7 of the scintillator 100 can be adhered to the sensor substrate 1 by an adhesive layer 8. The scintillator 100 can be sealed by a sealing portion 9.

The sealing portion 9 can have a function of reducing permeation of moisture into the scintillator 100, a function of reducing a shock applied to the scintillator 100 and sensor substrate 1, a function of preventing static electrification, and the like. The material of the sealing portion 9 is an organic or inorganic material excellent in antistatic property, moisture resistance, and cushioning. Examples of the material of the sealing portion 9 are an epoxy resin and urethane resin. For example, the sealing portion 9 can be formed by coupling the sensor substrate 1 and scintillator layer 5, spraying a resin for forming the sealing portion 9 to the periphery of the scintillator 100, and drying the resin.

A method of manufacturing the scintillator 100 and the radiation detection apparatus 200 in which the scintillator 100 is assembled according to the first embodiment will be explained with reference to FIGS. 2A to 2D. In a step shown in FIG. 2A, a covering layer 7 containing particles 72 for converting radiation into light is arranged in an undried state on a sensor substrate 1. At this time, the covering layer 7 may be arranged on an adhesive layer 8 on the sensor substrate 1. The covering layer 7 can be formed by applying a resin containing the particles 72 onto the sensor substrate 1 directly or via the adhesive layer 8 by a method such as spin coating, slit coating, or screen printing.

The adhesive layer 8 can be formed from, for example, a pressure sensitive adhesive double coated sheet, or a liquid curing pressure sensitive adhesive material or adhesive. To efficiently transfer light converted by the scintillator layer 5 to the sensor array SA, the adhesive layer 8 is preferably formed from an optical pressure sensitive adhesive sheet or material. The thickness of the adhesive layer 8 preferably falls within the range of, for example, 5 to 50 μm, and further preferably falls within the range of 5 to 20 μm. If the thickness of the adhesive layer 8 is smaller than 5 μm, no satisfactory adhesion is obtained, and the coupling strength between the scintillator layer 5 and the sensor substrate 1 can become unsatisfactory. If the thickness of the adhesive layer 8 exceeds 50 μm, scattering of light generated in the scintillator layer 5 by the adhesive layer 8 becomes large, and the quality (resolution) of an obtained image can degrade.

The material of the adhesive layer 8 is arbitrarily an organic or inorganic material. The adhesive layer 8 can be formed from, for example, an acrylic-based, epoxy-based, silicon-based, natural rubber-based, silica-based, urethane-based, ethylene-based, polyolefin-based, polyester-based, polyurethane-based, polyamide-based, or cellulose-based material. These materials may be used singly or as a mixture. As the structure of the pressure sensitive adhesive sheet, for example, a structure in which adhesive layers are formed on the two surfaces of a core made of PET or the like, or a structure in which a sheet is formed from a coreless single-layered pressure sensitive adhesive layer is usable.

In a step shown in FIG. 2B, a scintillator layer 5 is formed on a support substrate 4. At this time, protrusions 6 are formed on the scintillator layer 5. The support substrate 4 may be formed from an organic or inorganic material as long as the material hardly absorbs radiation. The support substrate 4 can be formed from, for example, carbon, CFRP, a polymeric material, PET, or aluminum. The support substrate 4 may have a reflection surface on the side of the scintillator layer 5. The support substrate 4 having the reflection surface can be obtained by forming the support substrate 4 or its surface from a material such as a metal having a high reflectivity, including aluminum or gold, or high-reflectivity PET. Alternatively, the surface of the support substrate 4 may undergo reflection work.

In a step shown in FIG. 2C, the scintillator layer 5 supported by the support substrate 4 is brought into contact with the covering layer 7 on the sensor substrate 1 so that the protrusions 6 of the scintillator layer 5 are inserted into the undried covering layer 7. After that, the covering layer 7 is dried. In a step shown in FIG. 2D, a sealing portion 9 is formed around the scintillator layer 5 to seal the scintillator layer 5. A radiation detection apparatus 200 is obtained through these steps.

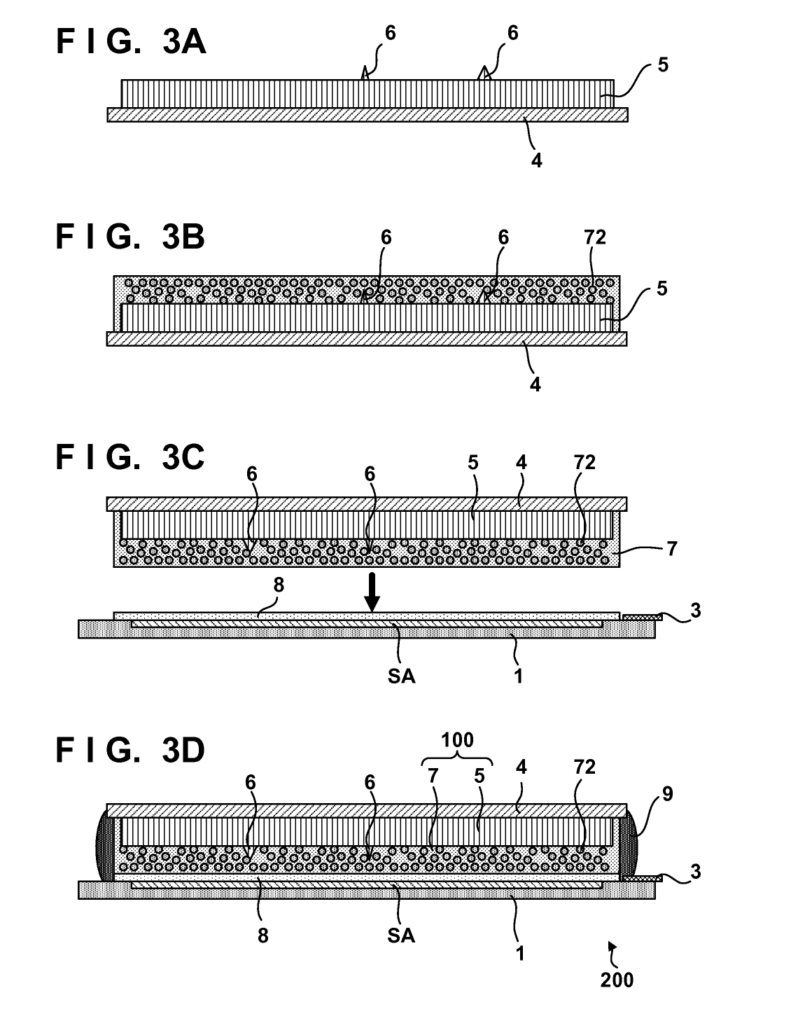

The second embodiment of the present invention will be described with reference to FIGS. 3A to 3D. Details not mentioned in the second embodiment can conform to those in the first embodiment unless a mismatch occurs. FIG. 3D shows the second embodiment of a scintillator 100 including a scintillator layer 5 and covering layer 7, and a radiation detection apparatus 200 in which the scintillator 100 is assembled. The radiation detection apparatus 200 according to the second embodiment includes the scintillator 100, a support substrate 4 which supports the scintillator layer 5 of the scintillator 100, and a sensor substrate 1.

A method of manufacturing the scintillator 100 and the radiation detection apparatus 200 in which the scintillator 100 is assembled according to the second embodiment will be explained with reference to FIGS. 3A to 3D. In a step shown in FIG. 3A, a scintillator layer 5 is formed on a support substrate 4. At this time, protrusions 6 are formed on the scintillator layer 5. In a step shown in FIG. 3B, a covering layer 7 containing particles 72 for converting radiation into light is formed on the scintillator layer 5 including the protrusions 6. The covering layer 7 can be formed by applying a resin containing the particles 72 onto the scintillator layer 5 by a method such as spin coating, slit coating, or screen printing, and then drying the resin.

In a step shown in FIG. 3C, the sensor substrate 1 and scintillator layer 5 are coupled by an adhesive layer 8. In a step shown in FIG. 3D, a sealing portion 9 is formed around the scintillator layer 5 to seal the scintillator layer 5. A radiation detection apparatus 200 is obtained through these steps.

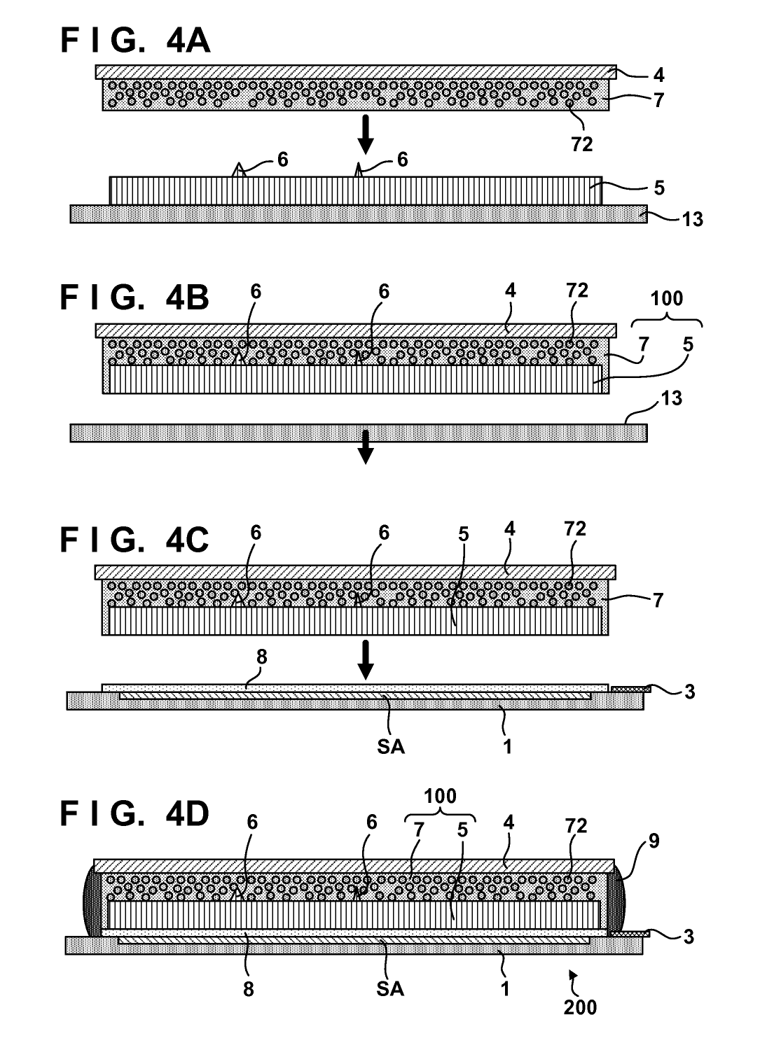

The third embodiment of the present invention will be described with reference to FIGS. 4A to 4D. Details not mentioned in the third embodiment can conform to those in the first embodiment unless a mismatch occurs. FIG. 4D shows the third embodiment of a scintillator 100 including a scintillator layer 5 and covering layer 7, and a radiation detection apparatus 200 in which the scintillator 100 is assembled. The radiation detection apparatus 200 according to the third embodiment includes the scintillator 100, a support substrate 4 which supports the scintillator layer 5 of the scintillator 100, and a sensor substrate 1.

A method of manufacturing the scintillator 100 and the radiation detection apparatus 200 in which the scintillator 100 is assembled according to the third embodiment will be explained with reference to FIGS. 4A to 4D. In a step shown in FIG. 4A, a scintillator layer 5 is formed on a substrate 13. At this time, protrusions 6 are formed on the scintillator layer 5. Also, in the step shown in FIG. 4A, a covering layer 7 containing particles 72 for converting radiation into light is arranged in an undried state on a support substrate 4. The covering layer 7 can be formed by applying a resin containing the particles 72 onto the support substrate 4 by a method such as spin coating, slit coating, or screen printing. Further, in the step shown in FIG. 4A, the scintillator layer 5 supported by the support substrate 4 is brought into contact with the covering layer 7 on the sensor substrate 1 so that the protrusions 6 of the scintillator layer 5 are inserted into the undried covering layer 7. After that, the covering layer 7 is dried. As a result, a scintillator (scintillator panel) 100 including the scintillator layer 5 and covering layer 7 is formed.

In a step shown in FIG. 4B, the scintillator layer 5 is removed from the substrate 13. In a step shown in FIG. 4C, the sensor substrate 1 and scintillator 100 are coupled by an adhesive layer 8. In a step shown in FIG. 4D, a sealing portion 9 is formed around the scintillator layer 5 to seal the scintillator layer 5. A radiation detection apparatus 200 is obtained through these steps.

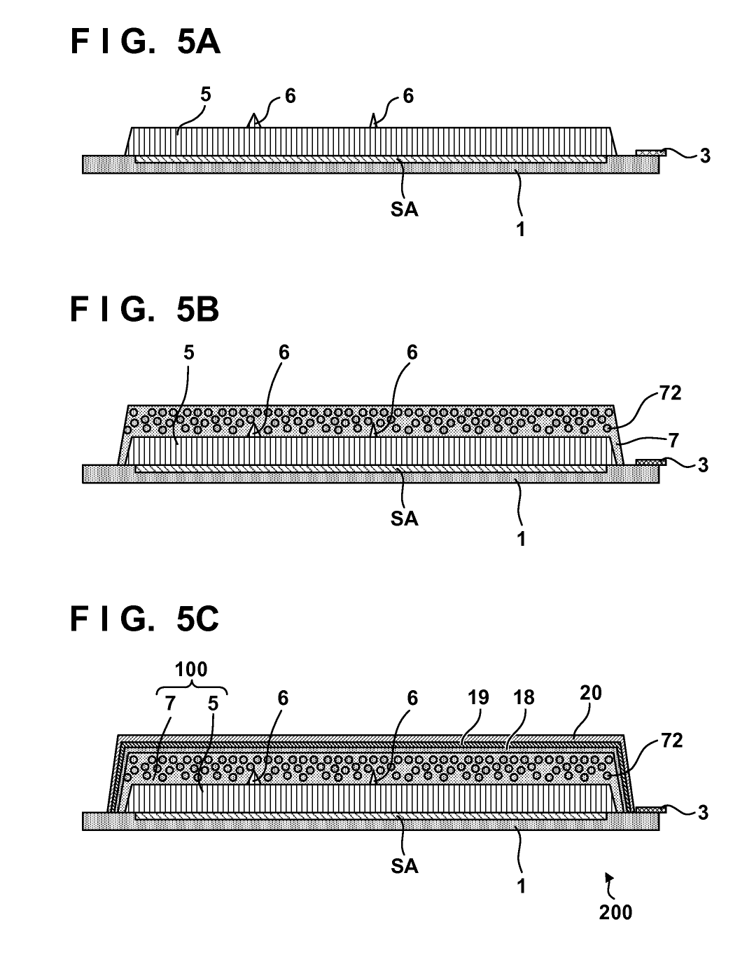

The fourth embodiment of the present invention will be described with reference to FIGS. 5A to 5C. Details not mentioned in the fourth embodiment can conform to those in the first embodiment unless a mismatch occurs. FIG. 5C shows the fourth embodiment of a scintillator 100 including a scintillator layer 5 and covering layer 7, and a radiation detection apparatus 200 in which the scintillator 100 is assembled. The radiation detection apparatus 200 according to the fourth embodiment includes the scintillator 100, a sensor substrate 1, an adhesive layer 18, a reflection layer 19, and a protection layer 20.

A method of manufacturing the scintillator 100 and the radiation detection apparatus 200 in which the scintillator 100 is assembled according to the fourth embodiment will be explained with reference to FIGS. 5A to 5C. In a step shown in FIG. 5A, a scintillator layer 5 is formed on a sensor substrate 1. At this time, protrusions 6 are formed on the scintillator layer 5. In a step shown in FIG. 5B, a covering layer 7 containing particles 72 for converting radiation into light is formed on the scintillator layer 5 including the protrusions 6. The covering layer 7 can be formed by applying a resin containing the particles 72 onto the scintillator layer 5 by a method such as spin coating, slit coating, or screen printing, and then drying the resin. In a step shown in FIG. 5C, a reflection layer 19 is formed on an adhesive layer 18 on the covering layer 7, and a protection layer 20 is formed to cover the reflection layer 19.

The reflection layer 19 reflects, toward the sensor substrate 1, light propagating toward a side opposite to the sensor substrate 1, out of light converted by the scintillator layer 5. The reflection layer 19 can be formed from a high-reflectivity metal thin film such as aluminum or gold, or a metal foil. Alternatively, the reflection layer 19 may be formed from a high-reflectivity plastic material. The thickness of the reflection layer 19 preferably falls within the range of, for example, 1 to 100 μm. If the reflection layer 19 is thinner than 1 μm, a pinhole defect is readily generated when forming the reflection layer 19. If the thickness of the reflection layer 19 exceeds 100 μm, the absorption of radiation becomes large, and the quality of an obtained image can degrade.

The adhesive layer 18 is used to couple the covering layer 7 and reflection layer 19 formed on the scintillator layer 5. The adhesive layer 18 can be formed from, for example, a pressure sensitive adhesive double coated sheet, or a liquid curing pressure sensitive adhesive material or adhesive. The thickness of the adhesive layer 18 preferably falls within the range of, for example, 10 to 200 μm. If the thickness of the adhesive layer 18 is smaller than 10 μm, no satisfactory adhesion is obtained, and the coupling strength between the covering layer 7 and the reflection layer 19 can become unsatisfactory. If the thickness of the adhesive layer 18 exceeds 200 μm, scattering of light generated in the scintillator layer 5 and light reflected by the reflection layer 19 becomes large, and the quality (resolution) of an obtained image can degrade.

The material of the adhesive layer 18 is arbitrarily an organic or inorganic material. The adhesive layer 18 can be formed from, for example, an acrylic-based, epoxy-based, silicon-based, natural rubber-based, silica-based, urethane-based, ethylene-based, polyolefin-based, polyester-based, polyurethane-based, polyamide-based, or cellulose-based material. Alternatively, the adhesive layer 18 may be formed from a hot-melt resin. These materials may be used singly or as a mixture.

The hot-melt resin is defined as an adhesive resin which contains neither moisture nor a solvent, is a solid at room temperature, and is made of a completely nonvolatile thermoplastic material. The hot-melt resin melts as the resin temperature rises, and solidifies as the resin temperature drops. The hot-melt resin has an adhesion property to other organic materials and inorganic materials in a molten state, and at room temperature, becomes solid and does not have the adhesion property. The hot-melt resin contains none of a polar solvent, solvent, and moisture. The hot-melt resin is different from a solvent evaporation curing adhesive resin prepared by a solvent application method of dissolving a thermoplastic in a solvent. The hot-melt resin is also different from a chemical reaction adhesive resin prepared by chemical reaction, typified by an epoxy resin. A sheet made up of the reflection layer 19 and protection layer 20, and the covering layer 7 may be coupled by the adhesive layer 18, or a sheet made up of the adhesive layer 18, reflection layer 19, and protection layer 20 may be coupled to the covering layer 7.

The protection layer 20 prevents damage to the reflection layer 19 by a shock, and corrosion of the reflection layer 19 by moisture. The protection layer 20 can be formed from a film material such as polyethylene terephthalate, polycarbonate, vinyl chloride, polyethylene naphthalate, or polyimide. The thickness of the protection layer 20 preferably falls within the range of, for example, 10 to 100 μm.

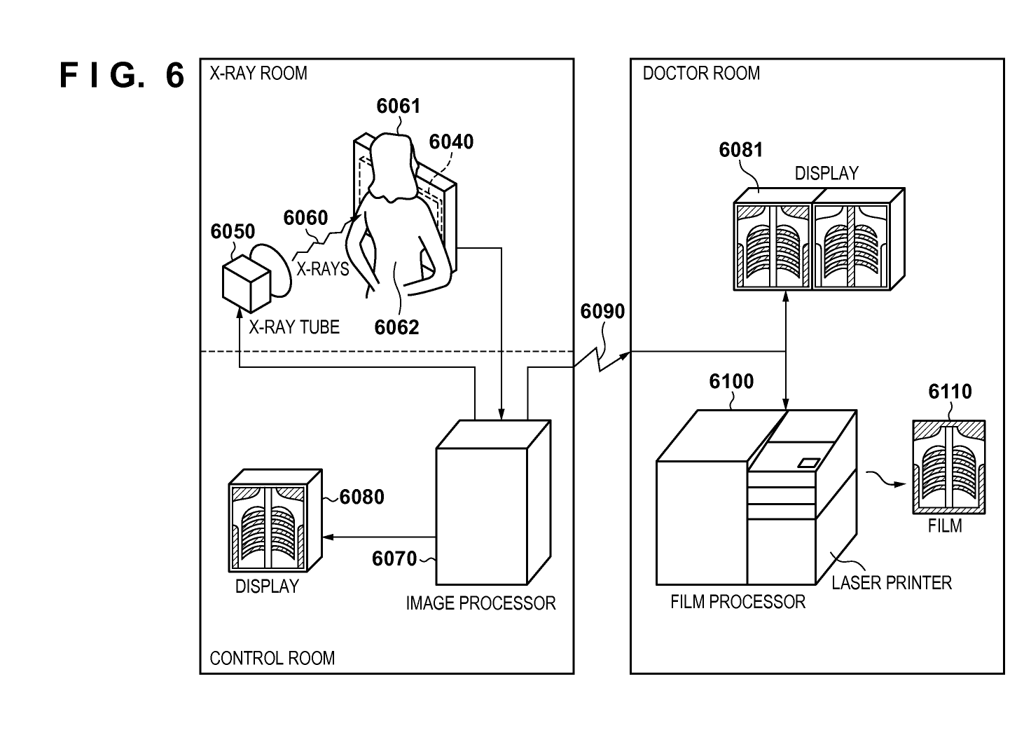

A radiation detection system in which the above-described radiation detection apparatus 200 is assembled will be exemplarily described with reference to FIG. 6. X-rays (radiation) 6060 generated by an X-ray tube (radiation source) 6050 pass through a chest 6062 of a subject 6061 and enter a radiation detection apparatus 6040 (corresponding to the above-described radiation detection apparatus 200) as shown in FIG. 6. The incident X-rays include in-vivo information of the subject 6061. The scintillator emits light in response to the entrance of the X-rays. The photoelectric converters of a sensor substrate detect the light, outputting an image from the sensor substrate. This information is digitally converted, undergoes image processing by an image processor 6070 serving as a signal processor, and can be observed on a display 6080 in a control room. A transmission processing means such as a network 6090 including a telephone, a LAN, or the Internet can transfer this information to a remote place. Accordingly, the information can be displayed on a display 6081 in a doctor room or the like at another place, and a doctor at a remote place can make a diagnosis. In addition, a film processor 6100 can record the information on a film 6110.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-278605, filed Dec. 20, 2012, which is hereby incorporated by reference herein in its entirety.

What is claimed is:

1. A scintillator comprising a scintillator layer including a plurality of columnar crystals configured to convert radiation into light, and a covering layer configured to cover the scintillator layer,
wherein the scintillator layer includes a protrusion, and
the covering layer covers the scintillator layer to prevent the protrusion from breaking through the covering layer, and contains particles configured to convert radiation into light.

2. The scintillator according to claim 1, wherein the protrusion is formed by abnormal growth when the plurality of columnar crystals grow.

3. The scintillator according to claim 1, wherein a ratio of a volume of the particles to a unit volume of the covering layer is 10% (inclusive) to 90% (inclusive).

4. The scintillator according to claim 1, wherein the covering layer is formed from a resin containing the particles.

5. The scintillator according to claim 1, wherein the particle is formed from the same material as a material of the columnar crystal.

6. The scintillator according to claim 1, wherein the particle has a dimension smaller than a diameter of the columnar crystal.

7. A radiation detection apparatus comprising:
a scintillator defined in claim 1; and
a sensor array configured to detect light converted by the scintillator.

8. A radiation detection system comprising:
a radiation detection apparatus defined in claim 7; and
a signal processor configured to process a signal from the radiation detection apparatus.
